(19) United States
(12) Patent Application Publication
(10) Pub. No.: US 2012/0062580 A1
(43) Pub. Date: Mar. 15, 2012

(54) DISPLAY DEVICE, DISPLAY METHOD, AND COMPUTER PROGRAM

(75) Inventors: Toshiyuki Shimada, Kanagawa (JP); Shigeru Harada, Tokyo (JP); Ryuhei Hata, Kanagawa (JP)

(73) Assignee: SONY CORPORATION, Tokyo (JP)

(21) Appl. No.: 13/113,436

(22) Filed: May 23, 2011

(30) Foreign Application Priority Data
May 31, 2010 (JP) P2010-124997

(51) Int. Cl. G09G 5/02

(52) U.S. Cl. 345/589

(57) ABSTRACT

A display device includes a first measurement unit measuring information on luminance of a first image signal to output a first measurement result, a second measurement unit measuring information on a luminance of a second image signal to output a second measurement result, a comparator comparing the first measurement result with the second measurement result to output differential data, a correction amount determination unit determining a correction amount for the first image signal and/or the second image signal based on the differential data, and a correction unit correcting the luminance of the first image signal and/or the second image signal based on the correction amount.

### BACKGROUND

The present disclosure relates to a display device, a display method, and a computer program, and more particularly, to a display device suitably applied when a stereoscopic three-dimensional image is displayed, a display method, and a computer program.

There is a display device allowing a viewer to perceive a image displayed on a screen as a stereoscopic three-dimensional image. In order for the viewer to perceive the image as a stereoscopic three-dimensional image, it is necessary to display the image on the screen using a display method different from a general display method. As an example of the display method, there is a method of allowing the viewer to perceive the image as a stereoscopic image by changing a polarization state of an image for a right eye and an image for a left eye (for example, see Japanese Unexamined Patent Application Publication No. 10-63199). A viewer may perceive the image displayed on the screen as a stereoscopic three-dimensional image by changing the polarization state of the image for the right eye and the image for the left eye and wearing glasses of which the polarization state is changed between left and right sides so that the image for the right eye may be viewed from the right eye and the image for the left eye may be viewed from the left eye.

In order for the viewer to perceive the image as a stereoscopic three-dimensional image, it is usual to capture the image for the right eye and the image for the left eye, respectively, generally using two cameras and displaying the captured image on the display device. Further, when the three-dimensional image is captured using two cameras, it is necessary unify the setting of two cameras, such as a type of a lens, a diaphragm, and characteristics of an image pick-up device so as to create an image without a luminance difference or a color difference in the left and right images.

### SUMMARY

However, when the setting of two cameras is different and the luminance difference or the color difference between two types of images captured arises, in the display device perceiving the three-dimensional image by the method of alternately displaying the left and right images, flickering may be seen, image quality may be deteriorated, and visibility, or the like, may be adversely affected.

In order to prevent the flickering, although a method of synchronizing the focuses and the diaphragms and, the gains of the image pick-up devices between two cameras with each other or the like, has been disclosed (for example, see Japanese Unexamined Patent Application Publication No. 8-242468), the method has a problem that a dedicated camera increase necessary costs. Further, when analyzing the three-dimensional images actually broadcast, the luminances of the left and right images may be different from each other and the luminances or the contrasts of two cameras may not be adjusted. For example, there may be an image having a difference of about 4% in an average luminance of the entire screen.

It is desirable to suppress occurrence of flickering when displaying a three-dimensional image by correcting a difference occurring between an image for a right eye and an image for a left eye in a case in which the difference between the image for the right eye and the image for the left eye occurs.

According to an embodiment of the present disclosure, there is provided a display device including: a first measurement unit measuring information on luminance of a first image signal to output a first measurement result; a second measurement unit measuring information on a luminance of a second image signal to output a second measurement result; a comparator comparing the first measurement result with the second measurement result to output differential data; a correction amount determination unit determining a correction amount for the first image signal and/or the second image signal based on the differential data; and a correction unit correcting the luminance of the first image signal and/or the second image signal based on the correction amount.

The first measurement unit and the second measurement unit may measure the information on colors of the first image signal and the second image signal to output the first measurement result and the second measurement result.

The first measurement unit and the second measurement unit may divide the first image signal and the second image signal into a plurality of areas to perform the measurement on each area.

The correction amount determination unit may determine the correction amount for only the area in which the first measurement result and the second measurement result are a predetermined threshold value or more.

The correction amount determination unit may determine the correction amount for only an area of a central portion in the plurality of areas. Further, the correction amount determination unit may determine the correction amount for only the area in which the first measurement result and the second measurement result are a predetermined threshold value or more.

The comparator may output a difference square sum of the first measurement result and the second measurement result as the differential data.

The correction amount determination unit may determine the correction amount in response to the contents of the image displayed by the first image signal and the second image signal.

The display device may further include a display unit displaying the three-dimensional image based on the corrected first image signal and second image signal.

The first measurement unit and the second measurement unit may apply weighting to information on a black side of the information on the measured luminance to output the first measurement result and the second measurement result.

According to an embodiment of the present disclosure, there is provided a display method including: measuring information on luminance of a first image signal to output a first measurement result; measuring information on a luminance of a second image signal to output a second measurement result; comparing the first measurement result with the second measurement result to output differential data; determining a correction amount for the first image signal and/or the second image signal based on the differential data; and correcting the luminance of the first image signal and/or the second image signal based on the correction amount.

According to an embodiment of the present disclosure, there is provided a computer program allowing a computer to execute: measuring information on luminance of a first image signal to output a first measurement result; measuring information on a luminance of a second image signal to output a second measurement result; comparing the first measurement result with the second measurement result to output differential data; determining a correction amount for the first image signal and/or the second image signal based on the differential data; and correcting the luminance of the first image signal and/or the second image signal based on the correction amount.

As set forth above, the embodiment of the present disclosure measures the information on the luminance of the first image signal, measures the information on the luminance of the second image signal, compares the first measurement result and the second measurement result to output the differential data, determines the correction amount for the first image signal and/or the second image signal based on the differential data, and corrects the luminance of the first image signal and/or the second image signal based on the correction amount.

### BRIEF DESCRIPTION OF THE DRAWINGS

FIG. 1 is a diagram illustrating an appearance of a display device according to an embodiment of the present disclosure;

FIG. 2 is a diagram illustrating a functional configuration of the display device according to the embodiment of the present disclosure;

FIG. 3 is a diagram illustrating a image signal controller;

FIG. 4 is a diagram illustrating an example in a case of dividing a image into a plurality of blocks when determining a correction amount;

FIG. 5 is a diagram illustrating a configuration of a comparator included in the image signal controller;

FIG. 6 is a flow chart illustrating an image correction method by the display device according to the embodiment of the present disclosure;

FIG. 7 is a flow chart illustrating the image correction method by the display device according to the embodiment of the present disclosure;

FIG. 8 is a diagram illustrating a configuration of an image signal controller that is a modified example of the image signal controller according to the embodiment of the present disclosure;

FIG. 9 is a flow chart illustrating the image correction method by the image signal controller according to the modified example of the embodiment of the present disclosure;

FIG. 10 is a diagram illustrating a configuration of an image signal controller;

FIG. 11 is a diagram illustrating a gain correction unit;

FIG. 12 is a diagram illustrating a process executed by the image signal controller;

FIG. 13 is a diagram illustrating a modified example of the image signal controller; and

FIGS. 14A and 14B are diagrams illustrating a calculation of an average value of luminance values.

### DETAILED DESCRIPTION OF EMBODIMENTS

Hereinafter, exemplary embodiments of the present disclosure will be described in detail with reference to the accompanying drawings. Further, in the present specification and the drawings, components having the substantially same functional configuration are denoted by the same reference numerals and a repetitive description thereof will be omitted.

Further, a description will be made in the following order.

### <1. Embodiment of Present Disclosure>

[1-1. Configuration of Display Device According to Embodiment of Present Disclosure]

[1-2. Functional Configuration of Display Device According to Embodiment of Present Disclosure]

[1-3. Configuration of Image Signal Controller]

[1-4. Configuration of Comparator]

[1-5. Image Correction Method]

### <2. Modified Example of Embodiment of Present Disclosure>

[2-1. Configuration of Image Signal Controller]

[2-2. Image Correction Method]

### <3. Detailed Example of Embodiment of Present Disclosure>

[3-1. Configuration of Image Signal Controller]

### <4. Overview>

### 1. Embodiment of Present Disclosure

### 1-1. Configuration of Display Device According to Embodiment of Present Disclosure

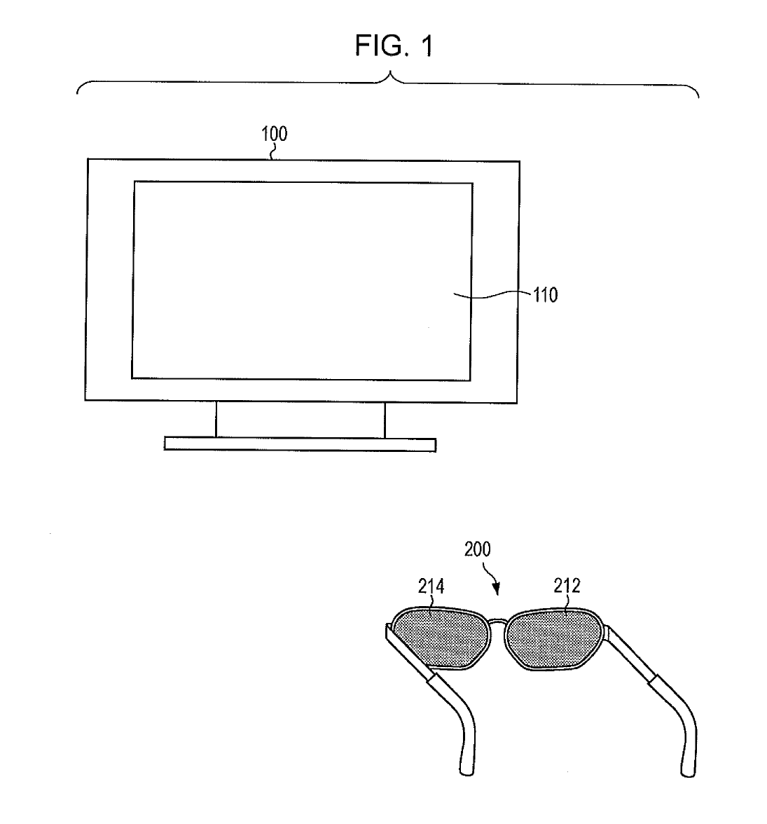

Hereinafter, a configuration of a display device according to an embodiment of the present disclosure will be described. First, an appearance of the display device according to the embodiment of the present disclosure will be described. FIG. 1 illustrates an appearance of a display device 100 according to an embodiment of the present disclosure. Further, FIG. 1 also illustrates shutter glasses 200 used to allow an observer to perceive an image displayed by the display device 100 as a stereoscopic image.

The display device 100 illustrated in FIG. 1 includes an image display unit 110 on which an image is displayed. The display device 100 is a device that may display a general image on the image display unit 110 and display the image perceived by the observer as the stereoscopic image on the image display unit 110.

Although the configuration of the image display unit 110 is described above, briefly describing this herein, the image display unit 110 is configured to include a light source, a liquid crystal panel, and a pair of polarizers having the liquid crystal panel interposed therebetween. Light from the light source becomes light polarized in a predetermined direction by transmitting the liquid crystal panel and the polarizers.

The shutter glasses 200 are configured to include an image transmitting unit 212 for a right eye and an image transmitting unit 214 for a left eye including, for example, a liquid crystal shutter. The shutter glasses 200 execute an opening and closing operation of the image transmitting unit 212 for the right eye and the image transmitting unit 214 for the left eye in response to a signal transmitted from the display device 100. The observer may see light emitted from the image display unit 110 through the image transmitting unit 212 for the right eye and the image transmitting unit 214 for the left eye of the shutter glasses 200 to perceive the image displayed on the image display unit 110 as the stereoscopic image.

Meanwhile, when the general image is displayed on the image display unit 110, the observer may see the light emitted from the image display unit 110 as it is to be perceived as the general image.

Further, although FIG. 1 illustrates the display device 100 as a television receiver, in the embodiment of the present disclosure, it goes without saying that the type of the display device is not limited to the above example. For example, the display device according to the embodiment of the present disclosure may be a monitor used by connecting to other electronic devices, for example, a personal computer, may be a portable game machine, or may be a cellular phone or a portable music player.

As described above, an appearance of the display device 100 according to the embodiment of the present disclosure will be described. Next, a functional configuration of the display device 100 according to the embodiment of the present disclosure will be described.

### 1-2. Functional Configuration of Display Device According to Embodiment of Present Disclosure

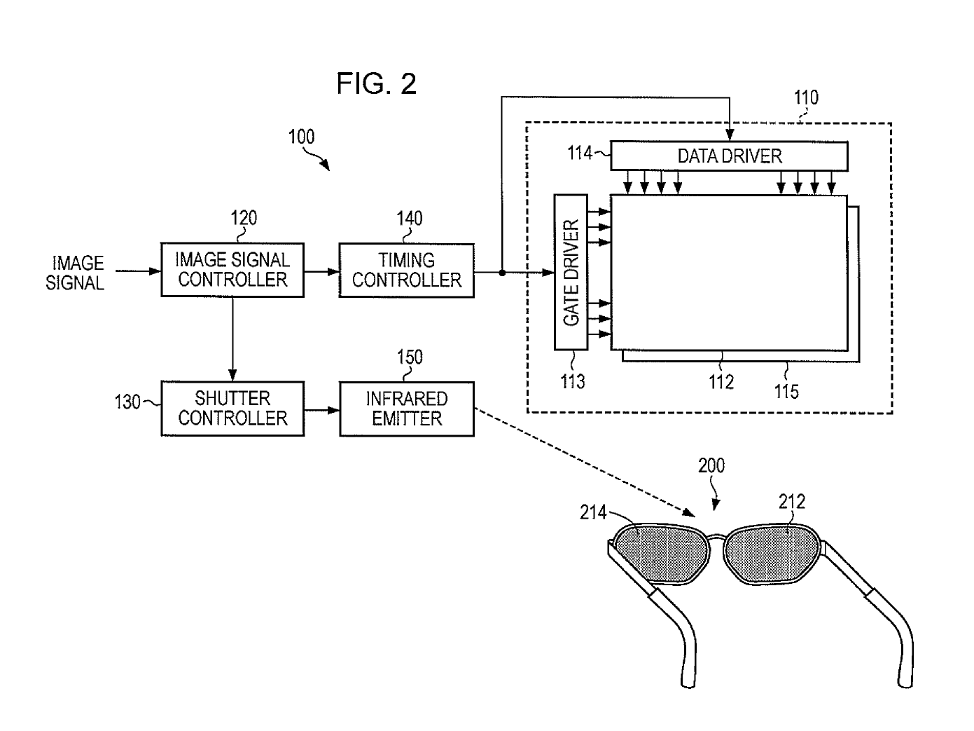

FIG. 2 illustrates a functional configuration of a display device 100 according to the embodiment of the present disclosure. Hereinafter, the functional configuration of the display device 100 according to the embodiment of the present disclosure will be described with reference to FIG. 2.

As shown in FIG. 2, the display device 100 according to the embodiment of the present disclosure is configured to include the image display unit 110, the image signal controller 120, a shutter controller 130, a timing controller 140, and an infrared emitter 150.

The image display unit 110 performs the display of the image as described above and performs the display of the image in response to the applied signal, when applied with a signal from the outside. The image display unit 110 is configured to include a display panel 112, a gate driver 113, a data driver 114, and a backlight 115.

The display panel 112 displays the image in response to the application of the signal from the outside. The display panel 112 displays the image by sequentially scanning a plurality of scanning lines. In the display panel 112, a liquid crystal molecule having a predetermined alignment state is sealed between transparent plates such as glass. A driving method of the display panel 112 may be a TN (twisted nematic) method, a VA (vertical alignment) method, or an IPS (in-phase-switching) method.

In the following description, although the driving method of the display panel 112 is described as the TN method unless particularly mentioned, it goes without saying that the embodiment of the present disclosure is not limited to the above example. Further, the display panel 112 according to the embodiment of the present disclosure is a display panel that may perform the rewriting of the screen at a high-speed frame rate (for example, 240 Hz). The embodiment of the present disclosure may alternately display the image for the right eye and the image for the left eye on the display panel 112 at a predetermined timing to allow the observer to perceive the images as the stereoscopic image.

The gate driver 113 is a driver for driving gate bus lines (not shown) of the display panel 112. The gate driver 113 receives a signal from the timing controller 140 and the gate driver 113 outputs the signal to the gate bus lines in response to the signal transmitted from the timing controller 140.

The data driver 114 is a driver that generates a signal for applying to data lines (not shown) of the display panel 112. The data driver 114 receives the signal from the timing controller 140 and the data driver 114 generates and outputs the signal applied to the data lines in response to the signal transmitted from the timing controller 140.

The backlight 115 is installed at the innermost of the image display unit 110 when being viewed from the observer side. When the image is displayed on the image display unit 110, white light that is not polarized (non-polarization) from the backlight 115 is emitted to the display panel 112 positioned at the observer side. As the backlight 115, for example, a light emitting diode may be used and a cold cathode tube may be used. Further, although FIG. 2 illustrates a surface light source as the backlight 115, in the embodiment of the present disclosure, a type of the light source is not limited to the above example. For example, the light source is disposed around the display panel 112 and the light from the light source may be emitted to the display panel 112 by being diffused by, for example, a diffusing plate. Further, for example, instead of the surface light source, a combination of a point light source and a condensing lens may be used.

When the image signal controller 120 receives the transmission of the image signal from the outside of the image signal controller 120, it performs and outputs a variety of signal processings on the received image signal so that the received image signal becomes suitable to be displayed as the three-dimensional image in the image display unit 110. The image signal subjected to the signal processing in the image signal controller 120 is transmitted to the timing controller 140. Further, when the signal processing is performed in the image signal controller 120, the predetermined signal is transmitted to the shutter controller 130 in response to the signal processing. The signal processing in the image signal controller 120 may include the following example.

When the image signal (the image signal for the right eye) for displaying the image for the right eye on the image display unit 110 and the image signal (the image signal for the left eye) for displaying the image for the left eye on the image display unit 110 are transmitted to the image signal controller 120, the image signal controller 120 generates the image signal for the three-dimensional image from two image signals. In the embodiment of the present disclosure, the image signal controller 120 generates the image signal to be displayed on the display panel 112 in an order of the image for right eye→the image for the right eye→the image for the left eye→the image for the left eye→the image for the right eye→the image for the right eye→ . . . from the image signal for the right eye and the image signal for the left eye that are input.

Further, the image signal controller 120 performs the color correction processing unifying colors by removing the color difference when the color difference between the image for the right eye and the image for the left eye occurs. In addition, the configuration and the color correction processing of the image signal controller 120 will be described below.

The shutter controller 130 receives the transmission of the predetermined signal generated in response to the signal processing in the image signal controller 120 and generates the shutter control signal controlling the shutter operation of the shutter glasses 200 in response to the signal. The shutter glasses 200 perform the opening and closing operation of the image transmitting unit 212 for the right eye and the image transmitting unit 214 for the left eye based on the shutter control signal generated in the shutter controller 130 and generated from the infrared emitter 150.

The timing controller 140 generates a pulse signal used for the operation of the gate driver 113 and the data driver 114 in response to the signal transmitted from the image signal controller 120. The image in response to the signal transmitted from the image signal controller 120 is displayed on the display panel 112 by generating the pulse signal in the timing controller 140 and receiving the pulse signal generated in the timing controller 140 by the gate driver 113 and the data driver 114.

Further, the timing controller 140 performs the predetermined signal processing when generating the pulse signal used for the operation of the gate driver 113 and the data driver 114. The timing controller 140 is an example of a driving compensator of the embodiment of the present disclosure. Crosstalk may be improved for a period in which the shutters of the shutter glasses 200 are opened by the predetermined signal processing in the timing controller 140. The predetermined signal processing in the timing controller 140 will be described below in detail.

As described above, the functional configuration of the display device 100 according to the embodiment of the present disclosure will be described with reference to FIG. 2. Next, a configuration of the image signal controller 120 according to an embodiment of the present disclosure will be described.

### 1-3. Configuration of Image Signal Controller

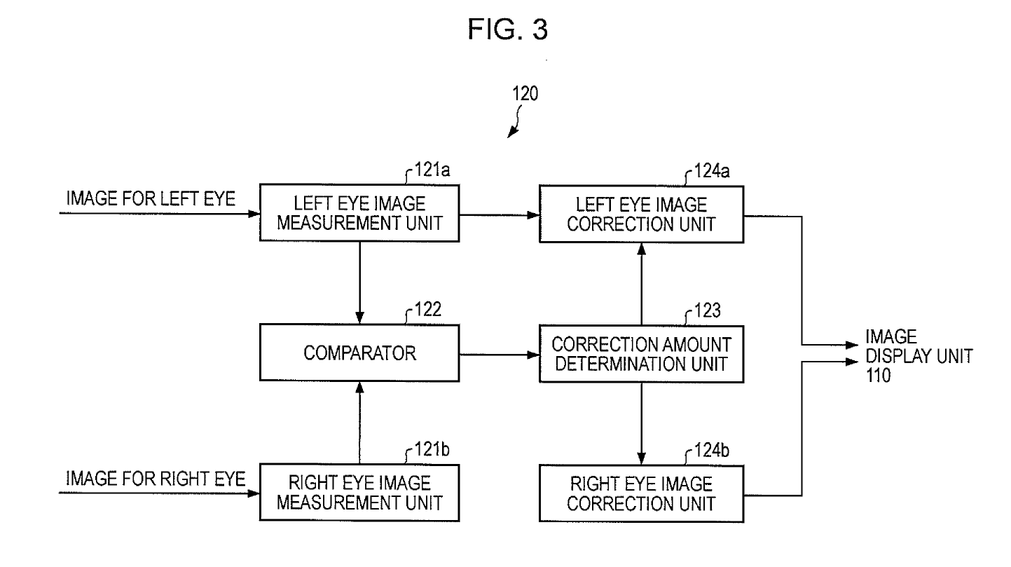

FIG. 3 is a diagram illustrating the image signal controller 120 included in the display device 100 according to the embodiment of the present disclosure. Hereinafter, the configuration of the image signal controller 120 according to the embodiment of the present disclosure will be described with reference to FIG. 3.

As shown in FIG. 3, the image signal controller 120 included in the display device 100 according to the embodiment of the present disclosure is configured to include a left eye image measurement unit 121a, a right eye image measurement unit 121b, the comparator 122, the correction amount determination unit 123, a left eye image correction unit 124a, and a right eye image correction unit 124b.

The left eye image measurement unit 121a measures a color difference (Cb and Cr) average, color difference (Cb and Cr) dispersion, and Hue histogram of the image signal for the left eye. The left eye image measurement unit 121a transmits the information on the color difference (Cb and Cr) average, the color difference (Cb and Cr) dispersion, and the Hue histogram, which are measured, to the comparator 122. In addition, the image signal (original image signal) for the left eye that is used for the measurement is transmitted to the left eye image correction unit 124a from the left eye image measurement unit 121a.

The right eye image measurement unit 121b measures the color difference (Cb and Cr) average, the color difference (Cb and Cr) dispersion, and the Hue histogram of the image signal for the right eye, similar to the left eye image measurement unit 121a. The right eye image measurement unit 121b transmits the information on the color difference (Cb and Cr) average, the color difference (Cb and Cr) dispersion, and the Hue histogram, which are measured, to the comparator 122. Further, the image signal (original image signal) for the right eye that is used for the measurement is transmitted to the right eye image correction unit 124b from the right eye image measurement unit 121b.

The comparator 122 compares the color difference (Cb and Cr) average, the color difference (Cb and Cr) dispersion, and the Hue histogram that are measured by the left eye image measurement unit 121a with the color difference (Cb and Cr) average, the color difference (Cb and Cr) dispersion, and the Hue histogram that are measured by the right eye image measurement unit 121b to generate the differential data between the image signal for the left eye and the image signal for the right eye. The differential data generated in the comparator 122 is transmitted to the correction amount determination unit 123.

The correction amount determination unit 123 determines the correction amount using the differential data generated by the results of comparing the color difference (Cb and Cr) average, the color difference (Cb and Cr) dispersion, and the Hue histogram that are measured by the left eye image measurement unit 121a with the color difference (Cb and Cr) average, the color difference (Cb and Cr) dispersion, and the Hue histogram that are measured by the right eye measurement unit 121b, all of which are transmitted from the comparator 122. The correction amount determination unit 123 may determine the correction amount by calculating the correction amount from the differential data, may determine the correction amount by referring to a lookup table from the differential data, and may determine the correction amount by other methods, when determining the correction amount. The information on the correction amount determined by the correction amount determination unit 123 is transmitted to the left eye image correction unit 124a and the right eye image correction unit 124b.

The correction amount determination unit 123 may also obtain the correction amount, for example, from the measurement result of the entire image and may also obtain the correction amount by dividing the image into the plurality of blocks and weighting a value of any specific block. When the correction amount is obtained by dividing the image into the plurality of blocks, a background portion considered as usually having the small difference is focused upon while considering the fact that the illumination of light to the object of interest within the image is different between the left and right sides. The correction amount determination unit 123 determines the correction amount so that the left and right differences of the background area become small while considering the fact that the difference of the background area indicates the left and right differences of the entire image. It is determined whether or not the area is the background area by using the luminance dispersion. In the image, the area having the small dispersion or the area having a smaller value than a threshold value may be the background area. The determination of the background area may also use the luminance data of the image.

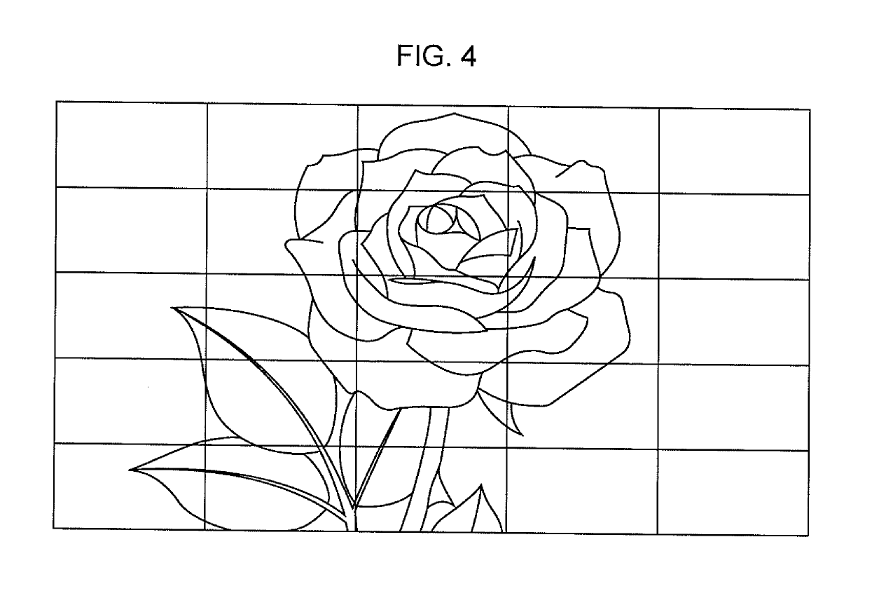

FIG. 4 illustrates an example in a case of dividing the image into the plurality of blocks when determining a correction amount in the correction amount determination unit 123. In the example shown in FIG. 4, one image is divided into a total of 25 blocks of five vertical blocks and five horizontal blocks and the luminance dispersion and the color difference dispersion in the left eye image measurement unit 121a and the right eye image measurement unit 121b are obtained for each block. The following tables 1 to 3 indicate the measurement results of the luminance dispersion and the color difference dispersion of any image divided into 25 blocks as shown in FIG. 4 in each block by the left eye image measurement unit 121a (or the right eye image measurement unit 121b). In each of the following tables, upper numbers indicate a block number numbered in a direction from upper left designated as 1 to lower right and lower numbers indicate the values of the luminance dispersion and the color difference dispersion in the blocks.

TABLE 1
Luminance Dispersion

| | | | | |
|---|---|---|---|---|
| 1 | 2 | 3 | 4 | 5 |
| 3275.39 | 7904.39 | 3677.4 | 218.061 | 61.2344 |
| 6 | 7 | 8 | 9 | 10 |
| 9333.79 | 1804.79 | 10710.6 | 3121.7 | 2027.65 |
| 11 | 12 | 13 | 14 | 15 |
| 4225.47 | 985.811 | 10697.7 | 5104.02 | 3757.48 |
| 16 | 17 | 18 | 19 | 20 |
| 7528.92 | 4090.52 | 19421.8 | 18804.3 | 1069.09 |
| 21 | 22 | 23 | 24 | 25 |
| 4256.98 | 1634.96 | 53853.9 | 17661 | 2289.64 |

TABLE 2
Color Difference (Cb) Dispersion

| | | | | |
|---|---|---|---|---|
| 1 | 2 | 3 | 4 | 5 |
| 14.8788 | 9.80628 | 2.84424 | 2.92616 | 1.02715 |
| 6 | 7 | 8 | 9 | 10 |
| 25.8062 | 11.1842 | 140.265 | 52.9425 | 21.3323 |
| 11 | 12 | 13 | 14 | 15 |
| 21.5558 | 14.8206 | 201.76 | 96.6705 | 31.0501 |
| 16 | 17 | 18 | 19 | 20 |
| 25.7481 | 12.7523 | 151.222 | 139.283 | 13.5302 |
| 21 | 22 | 23 | 24 | 25 |
| 32.7387 | 14.2374 | 258.574 | 111.755 | 10.5469 |

TABLE 3
Color difference (Cr) dispersion

| | | | | |
|---|---|---|---|---|
| 1 | 2 | 3 | 4 | 5 |
| 3.24234 | 0.552869 | 0.550317 | 2.90032 | 1.10636 |
| 6 | 7 | 8 | 9 | 10 |
| 7.40055 | 0.976194 | 182.321 | 37.356 | 27.2501 |
| 11 | 12 | 13 | 14 | 15 |
| 42.8247 | 10.2704 | 370.758 | 170.715 | 58.6445 |
| 16 | 17 | 18 | 19 | 20 |
| 20.4895 | 4.08491 | 133.718 | 41.0134 | 18.0753 |
| 21 | 22 | 23 | 24 | 25 |
| 37.4799 | 62.7435 | 143.834 | 27.953 | 6.14921 |

As described above, the luminance dispersion and the color difference dispersion are obtained in the left eye image measurement unit 121a (or the right eye image measurement unit 121b) by dividing the image into the blocks and the correction amount determination unit 123 does not perform the calculation of the correction amount on the blocks having a value less than the predetermined threshold value and may perform the calculation of the correction amount on only the blocks having a value of the predetermined threshold value or more.

For example, when the block having the luminance dispersion less than 3000 is excluded from the object of the correction amount calculation, in the above Table 1, a fourth block, a fifth block, a seventh block, a twelfth block, a twenty-second block, and a twenty-fifth block become the blocks which are excluded from the object of the correction amount calculation.

Further, for example, when the block having the color difference (Cb) dispersion less than 20 is excluded from the object of the correction amount calculation, in the above Table 1, a first block to a fifth block, a seventh block, a twelfth block, a seventeenth block, a twentieth block, a twenty-second block, and a twenty-fifth block become the blocks which are excluded from the object of the correction amount calculation.

Further, for example, when the block having the color difference (Cr) dispersion less than 20 is excluded from the object of the correction amount calculation, in the above Table 1, a first block to a seventh block, a twelfth block, a seventeenth block, and a twenty-fifth block become the blocks which are excluded from the object of the correction amount calculation.

Further, the blocks in which any one of the luminance dispersion and the color difference (Cb and Cr) dispersion is less than a threshold value by obtaining the luminance dispersion and the color difference dispersion may be excluded from the object of the correction amount calculation and the blocks in which all of the luminance dispersion and the color difference (Cb and Cr) dispersion are less than a threshold value may be excluded from the object of the correction amount calculation.

Various methods for performing the calculation processing of the correction amount in the correction amount determination unit 123 may be adopted. In one example, the correction amount may be determined so as to, for example, uniformly apply bias to each pixel and coefficients of a gamma curve may be adjusted in order to obtain the correction amount in response to the color difference and the Hue of each pixel. Further, for example, when using the method referring to the look-up table, the correction amount of the color difference and the Hue is held in the table and the correction amount of the color difference and Hue may be an amount obtained by multiplying a predetermined gain in the table.

The left eye image correction unit 124a performs the color correction processing on the image for the left eye based on the correction amount determined by the correction amount determination unit 123. Similarly, the right eye image correction unit 124b performs the color correction processing on the image for the right eye based on the correction amount determined by the correction amount determination unit 123. Further, since it may be very difficult to fully match the colors of the image for the left eye and the image for the right eye, in the embodiment of the present disclosure, the color correction processing is performed in the left eye image correction unit 124a and the right eye image correction unit 124b so that the difference between the image for the left eye and the image for the right eye is smaller than the threshold value.

In the display device 100 according to the embodiment of the present disclosure, when there is a color difference between two images by comparing the image for the left eye and the image for the right eye, the images may be corrected so as to match the colors of the image adopting any one of the image for the left eye and the image for the right eye as a reference with the colors of the image referenced beforehand and both of the images may be corrected so as to form the intermediate color of the image for the left eye and the image for the right eye.

As described above, the configuration of the image signal controller 120 according to the embodiment of the present disclosure was described with reference to FIG. 3. Further, in FIG. 3, when the differential data are generated, the comparator 122 may compare the color difference (Cb and Cr) average, the color difference (Cb and Cr) dispersion, and the Hue histogram that are measured by the left eye image measurement unit 121a with the color difference (Cb and Cr) average, the color difference (Cb and Cr) dispersion, and the Hue histogram that are measured by the right eye image measurement unit 121b to calculate the difference square sum therebetween, such that the difference square sum may be output as the differential data.

### 1-4. Configuration of Comparator 122

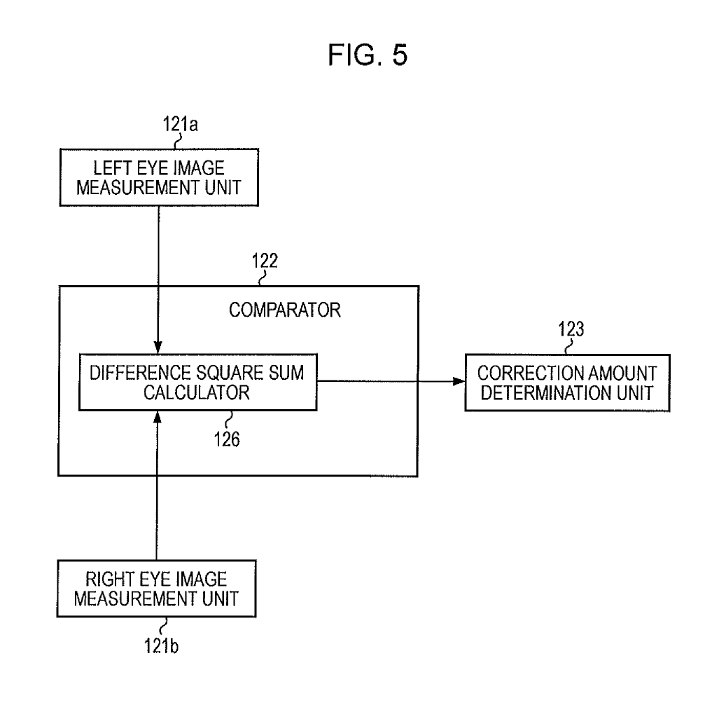

FIG. 5 illustrates the configuration of the comparator 122 included in the image signal controller 120 according to the embodiment of the present disclosure. As shown in FIG. 5, the comparator 122 included in the image signal controller 120 according to the embodiment of the present disclosure is configured to include a difference square sum calculator 126.

The difference square sum calculator 126 compares the color difference (Cb and Cr) average, the color difference (Cb and Cr) dispersion, and the Hue histogram that are measured by the left eye image measurement unit 121a with the color difference (Cb and Cr) average, the color difference (Cb and Cr) dispersion, and the Hue histogram that are measured by the right eye image measurement unit 121b to calculate the difference square sum therebetween. The difference square sum calculated by the difference square sum calculator 126 is transmitted to the correction amount determination unit 123 as the differential data.

### 1-5. Image Correction Method

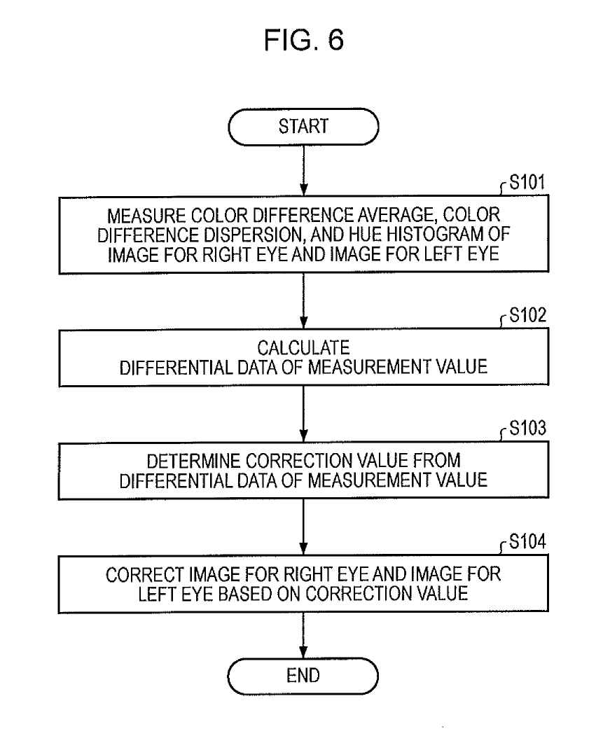

Next, the image correction method by the display device 100 according to the embodiment of the present disclosure will be described. FIG. 6 illustrates a flow chart of the image correction method by the display device 100 according to the embodiment of the present disclosure. Hereinafter, the image correction method by the display device 100 according to the embodiment of the present disclosure will be described with reference to FIG. 6.

In the display device 100 according to the embodiment of the present disclosure, in order to perform the correction so that the color of the image for the right eye matches the color of the image for the left eye, the left eye image measurement unit 121a and the right eye image measurement unit 121b measure the color difference (Cb and Cr) average, the color difference (Cb and Cr) dispersion, and the Hue histogram of the image for the left eye and the image for the right eye, respectively (step S101).

When the left eye image measurement unit 121a and the right eye image measurement unit 121b measure the color difference (Cb and Cr) average, the color difference (Cb and Cr) dispersion, and the Hue histogram of the image for the left eye and the image for the right eye, respectively, the comparator 122 receives the measurement value from the left eye image measurement unit 121a and the right eye image measurement unit 121b to calculate the differential data of the measurement value (step S102). The differential data may be differential data obtained by simply calculating the difference from the color difference (Cb and Cr) average, the color difference (Cb and Cr) dispersion, and the Hue histogram of the image for the left eye and the image for the right eye and the difference square sum may be differential data obtained by calculating the difference square sum therebetween.

When the differential data of the measurement value are calculated in the comparator 122, the correction amount for the image for the left eye or the image for the right eye is determined in the correction amount determination unit 123 based on the differential data calculated by the comparator 122 (step S103). Further, as described above, when the correction amount is determined, the correction amount may be obtained from the measurement results of the entire image and may be obtained by dividing the image into the plurality of blocks and weighting the value of any specific block. Further, as described above, when the correction amount may be determined in the correction amount determination unit 123, the correction amount may be determined by uniformly applying bias to each pixel and the coefficients of the gamma curve may be adjusted in order to obtain the correction amount in response to the color difference and the Hue of each pixel. Further, for example, when the correction amount determination unit 123 uses the method referring to the look-up table, the correction amount for the color difference and the Hue are held in the table and the correction amount for the color difference and Hue may be an amount obtained by multiplying a predetermined gain in the table.

When the correction amount for the image for the left eye or the image for the right eye is determined in the correction amount determination unit 123, the left eye image correction unit 124a and the right eye image correction unit 124b perform the color correction processing on the image for the left eye or the image for the right eye based on the correction amount determined by the correction amount determination unit 123 (step S104). As described above, in the embodiment of the present disclosure, when there is a color difference between two images by comparing the image for the left eye and the image for the right eye, the images may be corrected so as to match the colors of the image adopting any one of the image for the left eye and the image for the right eye as a reference with the colors of the image referenced beforehand and both of the images may be corrected so as to form the intermediate color of the image for the left eye and the image for the right eye.

As described above, the image correction method by the display device 100 according to the embodiment of the present disclosure was described with reference to FIG. 6. Further, in the embodiment of the present disclosure, the correction processing may be performed once and may be performed multiple times until the difference is less than the predetermined threshold value. Next, when the correction processing is performed multiple times, the image correction method by the display device 100 according to the embodiment of the present disclosure will be described.

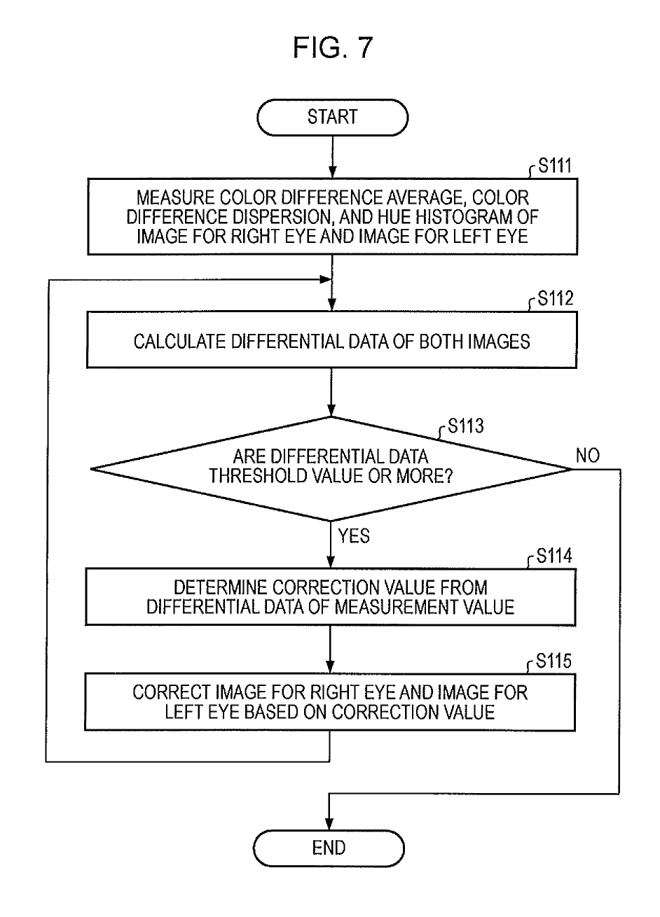

FIG. 7 illustrates a flow chart of the image correction method by the display device 100 according to the embodiment of the present disclosure when the correction processing is performed multiple times. Hereinafter, when the correction processing is performed multiple times, the image correction method by the display device 100 according to the embodiment of the present disclosure will be described with reference to FIG. 6.

First, similarly to the processing shown in FIG. 6, the left eye image measurement unit 121a and the right eye image measurement unit 121b measure the color difference (Cb and Cr) average, the color difference (Cb and Cr) dispersion, and the Hue histogram of the image for the left eye and the image for the right eye, respectively (Step S111). When the left eye image measurement unit 121a and the right eye image measurement unit 121b measure the color difference (Cb and Cr) average, the color difference (Cb and Cr) dispersion, and the Hue histogram of the image for the left eye and the image for the right eye, respectively, the differential data of the measurement value are calculated in the comparator 122 (step S112).

When the differential data of the measurement value are calculated in the comparator 122, subsequently, it is determined in the correction amount determination unit 123 whether the value of the calculated differential data is equal to or larger than a predetermined threshold value or not (step S113). If it is determined that the value of the calculated differential data is the predetermined threshold value or more, the correction amount determination unit 123 determines the correction amount for the image for the left eye or the image for the right eye based on the differential data calculated by the comparator 122 (step S114).

In this case, when the correction amount for the image for the left eye or the image for the right eye is determined in the correction amount determination unit 123, the left eye image correction unit 124a and the right eye image correction unit 124b performs the color correction processing on the image for the left eye or the image for the right eye based on the correction amount determined by the correction amount determination unit 123 (step S115). When the color correction processing is performed in the left eye image correction unit 124a and the right eye image correction unit 124b, the process returns to the above step S112 and the comparator 122 measures the color difference average, the color difference dispersion, and the Hue histogram of the image for the left eye or the image for the right eye, respectively, to calculate the differential data.

Meanwhile, at step S113, if the value of the differential data calculated by the comparator 122 is less than the predetermined threshold value, the process ends in this state.

As described above, when the correction processing is performed multiple times with reference to FIG. 7, the image correction method by the display device 100 according to the embodiment of the present disclosure will be described. As such, even though there is the color difference or the brightness difference between the image for the left eye and the image for the right eye, both of the images may be corrected to have the same color or brightness by measuring the color difference average, the color difference dispersion, and the Hue histogram of the image for the left eye and the image for the right eye, calculating the differential data of the measurement result, and obtaining the correction amount for the image for the left eye and the image for the right eye based on the differential data.

By correcting the image for the right eye and the image for the left eye as described above, it is not necessary to control and synchronize the cameras when capturing the three-dimensional image, the improvement of the image quality may be expected due to the reduction in the flickering between the left and right images, and the image easily displayed stereoscopically due to the reduction in the flickering between the left and right images may be generated in the display device. Further, the color of the object of interest may be maintained in the image when the user performs the stereoscopic view, by dividing the image into the plurality of blocks to calculate the correction amount.

In addition, in the above description, although the color difference average, the color difference dispersion, and the Hue histogram of the image for the left eye and the image for the right eye are measured to calculate the differential data of the measurement results, the occurrence of the flickering when the user performs the stereoscopic view may be suppressed by measuring only the luminance histogram of the image for the left eye and the image for the right eye. In the following description, as a modified example of the embodiment of the present disclosure, the display device suppressing the occurrence of the flickering by measuring the luminance histogram of the image for the left eye and the image for the right eye and calculating the differential data will be described.

### 2. Modified Example of Embodiment of Present Disclosure

### 2-1. Configuration of Image Signal Controller

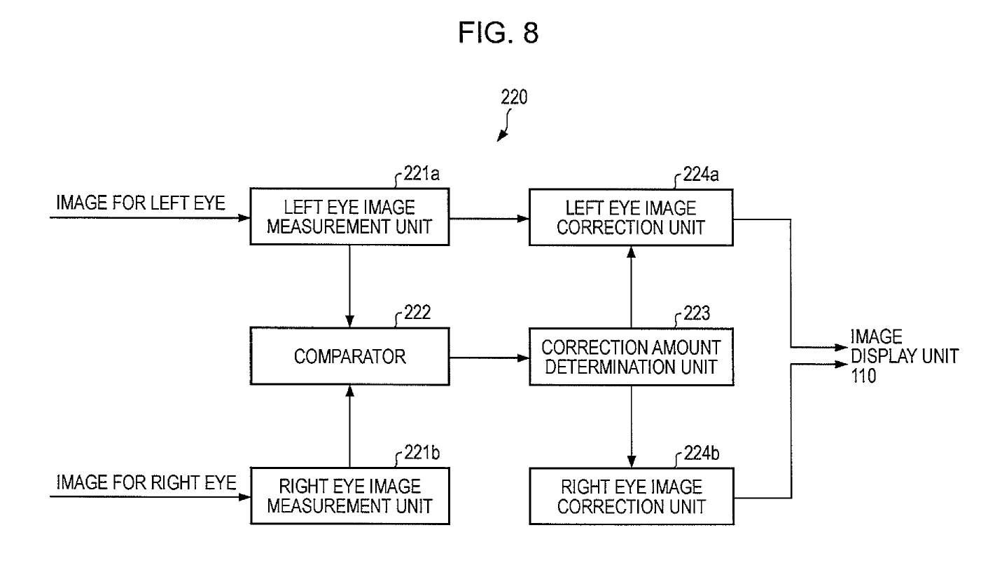

FIG. 8 illustrates a configuration of an image signal controller 220 that is a modified example of the image signal controller 120 according to the embodiment of the present disclosure. Hereinafter, the configuration of the image signal controller 220 that is a modified example of the image signal controller 120 according to the embodiment of the present disclosure will be described with reference to FIG. 7.

As shown in FIG. 8, the image signal controller 220 is configured to include a left eye image measurement unit 221a, a right eye image measurement unit 221b, a comparator 222, a correction amount determination unit 223, a left eye image correction unit 224a, and a right eye image correction unit 224b.

The left eye image measurement unit 221a measures the luminance average, the luminance dispersion, and the luminance histogram of the image signal for the left eye. The information on the luminance average, the luminance dispersion, and the luminance histogram that are measured by the left eye image measurement unit 221a is transmitted to the comparator 222. Further, the image signal (original image signal) for the left eye that is used for the measurement is transmitted to the left eye image correction unit 224a from the left eye image measurement unit 221a.

The right eye image measurement unit 221b measures the luminance average, the luminance dispersion, and the luminance histogram of the image signal for the right eye, similarly to the left eye image measurement unit 221a. The information on the luminance average, the luminance dispersion, and the luminance histogram that are measured by the right eye image measurement unit 121b are transmitted to the comparator 222. Further, the image signal (original image signal) for the right eye that is used for the measurement is transmitted to the right eye image correction unit 224b from the right eye image measurement unit 221b.

The comparator 222 compares the luminance average, the luminance dispersion, and the luminance histogram that are measured by the left eye image measurement unit 221a with the luminance average, the luminance dispersion, and the luminance histogram that are measured by the right eye image measurement unit 221b to generate the differential data between the image signal for the left eye and the image signal for the right eye. The differential data generated in the comparator 222 is transmitted to the correction amount determination unit 223.

The correction amount determination unit 223 determines the correction amount using the differential data generated as the result of comparing the luminance average, the luminance dispersion, and the luminance histogram that are measured by the right eye image measurement unit 221a with the luminance average, the luminance dispersion, and the luminance histogram that are measured by the left eye image measurement unit 221b, which are transmitted from the comparator 222. The correction amount determination unit 223 may determine the correction amount by calculating the correction amount from the differential data, may determine the correction amount by referring to a lookup table from the differential data, and may determine the correction amount by other methods, when determining the correction amount. The information on the correction amount determined by the correction amount determination unit 223 is transmitted to the left eye image correction unit 224a and the right eye image correction unit 224b.

The correction amount determination unit 223 may also obtain the correction amount, for example, from the measurement result of the entire image and may also obtain the correction amount by dividing the image into the plurality of blocks and weighting a value of any specific block. When the correction amount is obtained by dividing the image into the plurality of blocks, a background portion considered as usually having the small difference is focused on while considering the fact that the illumination of light to the object of interest within the image is different between the left and right sides. The correction amount determination unit 223 determines the correction amount so that the left and right differences of the background area become small while considering the fact that the difference of the background area indicates the left and right differences of the entire image. It is determined whether or not the area is the background area by using the luminance dispersion. In the image, the area having the small dispersion or the area having a smaller value than a threshold value may be the background area. The determination of the background area may also use the luminance data of the image.

In the present modified example, the correction amount determination unit 223 does not perform the calculation of the correction amount on the block having a value less than the predetermined threshold value and may perform the calculation of the correction amount on only the block having a value of the predetermined threshold value or more, by dividing the image into the plurality of blocks and obtaining the luminance dispersion in the left eye image measurement unit 221a and the right eye image measurement unit 221b as shown in FIG. 4.

For example, when the block having the luminance dispersion less than 3000 is excluded from the object of the correction amount calculation, in the above Table 1, a fourth block, a fifth block, a seventh block, a twelfth block, a twenty-second block, and a twenty-fifth block become the blocks which are excluded from the object of the correction amount calculation.

Further, similarly to the above-mentioned correction amount determination unit 123, various methods for the calculation processing of the correction amount in the correction amount determination unit 223 may be adopted. In one example, the correction amount may be determined so as to, for example, uniformly apply bias to each pixel and the coefficients of the gamma curve may be controlled in order to obtain the correction amount in response to the luminance of each pixel. Further, for example, when using the method referring to the look-up table, the correction amount for the luminance is held in the table and the correction amount for the luminance may be an amount obtained by multiplying predetermined gains in the table.

The left eye image correction unit 224a performs the luminance gain control processing on the image for the left eye based on the correction amount determined by the correction amount determination unit 223. Similarly, the right eye image correction unit 224b performs the luminance gain control processing on the image for the right eye based on the correction amount determined by the correction amount determination unit 223. Further, since it may be very difficult to fully match the colors of the image for the left eye and the image for the right eye, in the embodiment of the present disclosure, the luminance gain control processing is performed in the left eye image correction unit 224a and the right eye image correction unit 224b so that the difference between the image for the left eye and the image for the right eye is smaller than the threshold value.

In the modified example of the embodiment of the present disclosure, when there is the color difference between two images by comparing the image for the left eye and the image for the right eye, the images may be corrected so as to match the luminance of the image adopting either one of the image for the left eye and the image for the right eye as a reference and the other one thereof as a reference and both of the images may be corrected so as to form the intermediate luminance of the image for the left eye and the image for the right eye.

As described above, the configuration of an image signal controller 220 that is a modified example of the image signal controller 120 according to the embodiment of the present disclosure was described. In addition, similarly to the above-mentioned comparator 122, when generating the differential data, the comparator 222 in FIG. 5 compares the luminance average, the luminance dispersion, and the luminance histogram that are measured by the left eye image measurement unit 221a with the luminance average, the luminance dispersion, and the luminance histogram that are measured by the right eye image measurement unit 221b to calculate the difference square sum therebetween, such that the difference square sum may be output as the differential data.

### 2-2. Image Correction Method

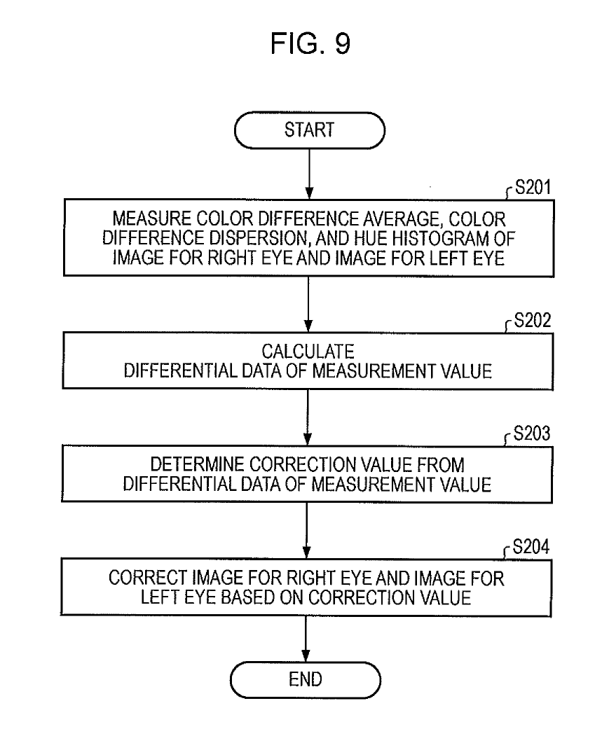

Next, the image correction method by an image signal controller 220 that is a modified example of the image signal controller 120 according to the embodiment of the present disclosure will be described. FIG. 9 illustrates a flow chart of the image correction method by the image signal controller 220 that is a modified example of the image signal controller 120 according to the embodiment of the present disclosure. Hereinafter, the image correction method of the image signal controller 220 that is a modified example of the image signal controller 120 according to the embodiment of the present disclosure will be described with reference to FIG. 9.

In the image signal controller 220 according to the present modified example, in order to perform the correction so that the luminance of the image for the right eye matches that of the image for the left eye, the left eye image measurement unit 221a and the right eye image measurement unit 221b first measure the luminance average, the luminance dispersion, and the luminance histogram of the image for the left eye and the image for the right eye, respectively (step S201).

When the left eye image measurement unit 221a and the right eye image measurement unit 221b measure the luminance average, the luminance dispersion, and the luminance histogram of the image for the left eye and the image for the right eye, respectively, the differential data of the measurement value is calculated in the comparator 222 (step S202). The differential data may be the differential data obtained by simply calculating the difference from the luminance average, the luminance dispersion, and the luminance histogram of the image for the left eye and the image for the right eye and the difference square sum may be the differential data obtained by calculating the difference square sum of both of the images.

When the differential data of the measurement value are calculated in the comparator 222, the correction amount for the image for the left eye or the image for the right eye is determined in the correction amount determination unit 223 based on the differential data calculated by the comparator 222 (step S203). Further, as described above, when the correction amount is determined, the correction amount may be obtained from the measurement results of the entire image and may be obtained by dividing the image into the plurality of blocks and applying weighting to the value of any specific block. Further, as described above, when the correction amount is determined in the correction amount determination unit 123, the correction amount may be determined by uniformly applying bias to each pixel and the coefficients of the gamma curve may be controlled in order to obtain the correction amount in response to the luminance of each pixel. Further, for example, when the correction amount determination unit 123 uses the method referring to the look-up table, the correction amount for the luminance is held in the table and the correction amount for the luminance may be an amount obtained by multiplying a predetermined gain in the table.

When the correction amount for the image for the left eye or the image for the right eye is determined in the correction amount determination unit 123, the left eye image correction unit 124a and the right eye image correction unit 124b performs the luminance correction processing on the image for the left eye or the image for the right eye based on the correction amount determined by the correction amount determination unit 123 (step S204). As described above, in the embodiment of the present disclosure, when there is the luminance difference between two images by comparing the image for the left eye and the image for the right eye, the images may also be corrected so as to match the luminance of the image adopting any one of the image for the left eye and the image for the right eye as a reference and the other one thereof as a reference and both of the images may be corrected so as to form the intermediate luminance of the image for the left eye and the image for the right eye.

As described above, the image correction method by the display device 100 according to the embodiment of the present disclosure was described with reference to FIG. 9. Further, even in the present modified example, the correction processing by the image signal controller 220 may be performed once and may be performed multiple times until the difference is less than the predetermined threshold value.

As such, even though there is the luminance difference between the image for the left eye and the image for the right eye, both of the images may be corrected to have the same brightness by measuring the luminance average, the luminance dispersion, and the luminance histogram of the image for the left eye and the image for the right eye, calculating the differential data of the measurement result, and obtaining the correction amount of the luminance for the image for the left eye and the image for the right eye based on the differential data.

By correcting the image for the right eye and the image for the left eye as described above, it is not necessary to control and synchronize the cameras when capturing the three-dimensional image, the improvement of the image quality may be expected due to the reduction in the flickering between the left and right images, and the image easily displayed stereoscopically due to the reduction in the flickering between the left and right images may be generated in the display device. Further, the brightness of the object of interest may be maintained in the image when the user performs the stereoscopic view, by dividing the image into the plurality of blocks to calculate the correction amount.

Further, although the embodiment of the present disclosure and the modified example thereof describe the display device 100 providing the stereoscopic view to the viewer by the shutter glasses 200, the present disclosure is not limited thereto. Similarly, it goes without saying that the present disclosure may also be applied to the display device providing the stereoscopic view to the viewer without using the shutter glasses 200.

### 3. Detailed Example of Embodiment of Present Disclosure

### 3-1. Configuration of Image Signal Controller

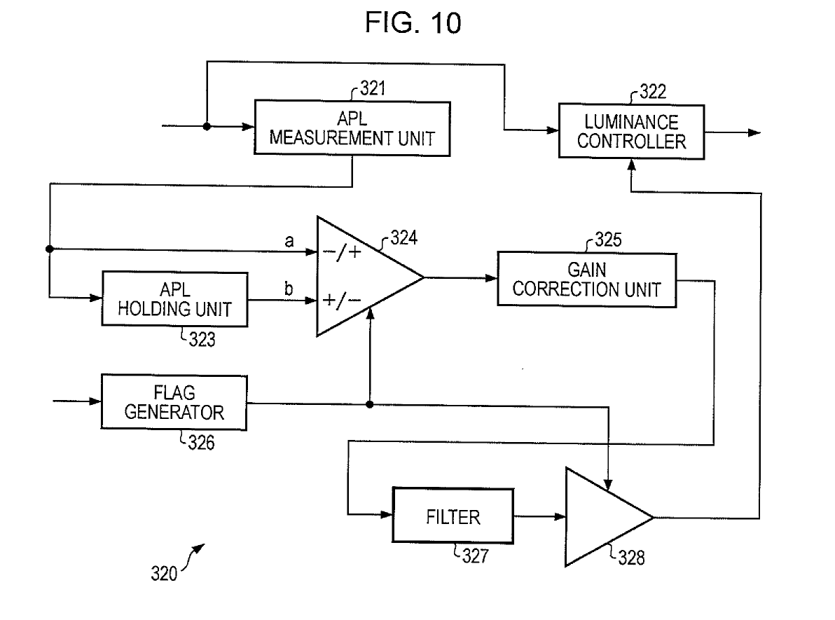

FIG. 10 illustrates a configuration of a image signal controller 320 that is a modified example (detailed example) of the image signal controller 120 according to the embodiment of the present disclosure. The image signal controller 320 shown in FIG. 10 is configured to include an average picture level (APL) measurement unit 321, a luminance controller 322, an APL holding unit 323, a calculator 324, a gain correction unit 325, a filter 327, and an amplifier 328.

The APL measurement unit 321 measures an average value of the input image signals. In this case, the calculation of the average value of the luminance values will be continuously described. The APL measurement unit 321 corresponds to the left eye image measurement unit 121a and the right eye image measurement unit 121b of the image signal controller 120 in FIG. 3. The APL measurement unit 321 may be configured to alternately input the image signal of the image for the left eye and the image signal of the image for the right eye. The APL measurement unit 321 may be configured to include the portion measuring the luminance average value from the image signal of the image for the left eye and the portion of measuring the luminance average value from the image signal of the image for the right eye, respectively, that is, may be configured as shown in FIG. 3.

The luminance average value from the APL measurement unit 321 is supplied to the APL holding unit 323 and the calculator 324. The APL holding unit 323 holds the average luminance value measured from the image signal of a frame earlier by one frame than the luminance average value (the luminance average value output from the APL measurement unit 321) input to the calculator 324. The APL holding unit 323 has a function of performing delay processing in order to supply the luminance average value prior to one frame to the calculator 324 by the APL measurement unit 321.

The calculator 324 is supplied with the luminance average value from the APL measurement unit 321 and the luminance average value from the APL holding unit 323. As described above, the APL measurement unit 321 is alternately input with the image signal of the image for the left eye and the image signal of the image for the right eye. Therefore, the luminance average value measured from the image signal of the image for the left eye and the luminance average value measured from the image signal of the image for the right eye are alternately output from the APL measurement unit 321.

Therefore, when the luminance average value of the image for the left eye is output from the APL measurement unit 321, the APL holding unit 323 is in a state in which the luminance average value of the image for the right eye prior to one frame is held. In this case, the calculator 324 is supplied with the luminance average value of the image for the left eye from the APL measurement unit 321 and is supplied with the luminance average value of the image for the right eye from the APL holding unit 323. Further, when the luminance average value of the image for the right eye is output from the APL measurement unit 321, the APL holding unit 323 is in a state in which the luminance average value of the image for the left eye prior to one frame is held. In this case, the calculator 324 is supplied with the luminance average value of the image for the right eye from the APL measurement unit 321 and is supplied with the luminance average value of the image for the left eye from the APL holding unit 323.

As described above, the calculator 324 is supplied with the luminance average value of the image for the left eye and the luminance average value of the image for the right eye. The calculator 324 subtracts the luminance average value of one side from the luminance average value of the other side and outputs the difference value to the gain correction unit 325. In this case, the subtraction of the luminance average value of the image for the left eye from the luminance average value of the image for the right eye will be continuously described.

The luminance average value from the APL measurement unit 321 is input to a terminal a of the calculator 324 and the luminance average value from the APL measurement unit 321 is input to a terminal b of the calculator 324. In this case, when the luminance average value of the image for the right eye is input to the terminal a, the terminal a becomes positive (+). In this case, since the terminal b is input with the luminance average value of the image for the left eye, the terminal b becomes negative (−). Further, when the luminance average value of the image for the left eye is input to the terminal a, the terminal a becomes negative (−). In this case, since the terminal b is input with the luminance average value of the image for the right eye, the terminal b becomes positive (+). As described above, since the luminance average value of the image for the right eye becomes positive at all times and the luminance average value of the image for the left eye becomes negative by attaching a sign, the luminance average value of the image for the left eye is subtracted from the luminance average value of the image for the right eye to calculate the difference value.

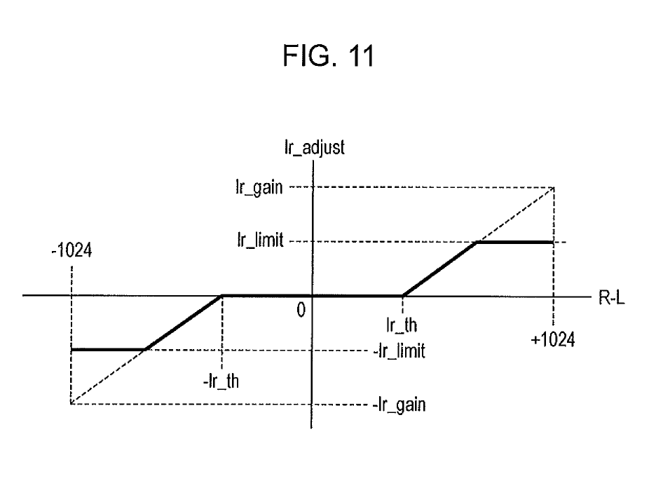

The gain correction unit 325 calculates the value of the corrected gain (correction amount) from the input difference value. In this case, the correction method of the gain of the gain correction unit 325 will be described. The gain correction unit 325 corrects the gain based on, for example, the gain correction curve shown in FIG. 11.

A horizontal axis of the gain correction curve shown in FIG. 11 indicates the difference value (R-L in FIG. 11) of the luminance average value of the image for the right eye and the luminance average value of the image for the left eye and the vertical axis thereof is a correction amount (lr adjust in FIG. 11). When the difference value exists between a first threshold value (−lr th in FIG. 11) and a second threshold value (lr th in FIG. 11), the correction amount becomes 0. Generally, even though the image for the right eye and the image for the left eye are in a normal state, for example, a state in which a symptom, for example, flickering does not occur, the difference in the luminance may occur (there is a slight difference in the APL). In this case, when the difference value exists between the first threshold value and the second threshold value, a dead zone having the correction amount of 0 is installed so as not to perform the correction.

When the difference value becomes the first threshold value or less, the correction amount is increased as a linear function (in this case, increased in a negative direction) and when the difference value exceeds a constant value, the correction amount also becomes a constant value (−lr limit). Similarly, when the difference value becomes the second threshold value or more, the correction amount is increased as a linear function (in this case, increased in a positive direction) and when the difference value exceeds a constant value, the correction amount also becomes a constant value (lr limit).

When the difference value exceeds the constant value, the reason for making the correction amount the constant value is that the rapid change in, for example, the luminance value due to, for example, the change of a scene is considered. If the luminance value is rapidly changed due to the change of the scene, the difference value also becomes large. However, under the above-mentioned situation, when the correction amount becomes large according to the size of the difference value, even though the rapid change of the luminance value is correct, the correction is performed by the large correction amount according to the rapid change, such that the incorrect correction is performed. In the case of the constant difference value or more, the above-mentioned situation does not occur by making the correction amount the constant value.

The gain correction unit 325 (FIG. 10) holds the above-mentioned gain correction curve and calculates the correction amount corresponding to the input difference value, which is in turn output to the filter 327. Further, the gain correction unit 325 may be configured to calculate (read) the correction amount by holding the gain correction curve as the look-up table that associates, for example, the difference value with the correction amount and referring to the look-up table. Further, the gain correction unit 325 may be configured to calculate the correction amount by performing the calculation from the input difference value.

The correction amount from the gain correction unit 325 is supplied to the filter 327. The filter 327 may be configured as, for example, an infinite impulse response (IIR) filter. The filter 327 is installed to absorb the rapid change. For example, when the correction amount from the gain correction unit 325 is rapidly changed, for example, when the correction amount is changed from the negative correction amount to the positive correction amount, it is considered that the rapid change in the luminance may be caused even in the corrected image. The filter 327 is installed so as not to cause the above-mentioned rapid change and therefore, any filter having the above-mentioned function may be applied as the filter 327.

The amplifier 328 amplifies the output from the filter 327 at a predetermined magnification. For example, the amplifier 328 may amplify the input correction amount at a magnification of ½. Further, the correction amount that is not amplified by the amplifier 328 and previously amplified at ½ times by the gain correction unit 325 may be output.

The amplifier 328 performs the amplification as well as the inversion processing of the sign of the correction amount, if necessary. In detail, when the image signal of the image for the right eye is input, the positive sign is multiplied and when the image signal of the image for the left eye is input, the negative sign is multiplied. Therefore, in this case, the amplifier 328 multiplies (½) when the image signal of the image for the right eye is input and multiplies (−½) when the image signal of the image for the left eye is input.

As described above, the calculator 324 and the amplifier 328 convert the sign according to whether the image signal input to the APL measurement unit 321 is the image for the right eye or the image for the left eye and processes the image signal. For this reason, a flag showing whether the image signal input to the APL measurement unit 321 is the image for the right eye or the image for the left eye is input to the calculator 324 and the amplifier 328 and a flag generator 326 generating the flag and the image signal controller 320 shown in FIG. 10 are configured.

The flag generator 326 is input with, for example, a V synchronization signal. The flag generator 326 is configured to determine whether the image signal is the image for the right eye or the image for the left eye from the input V synchronization signal and generate the flag. Further, the flag generator 326 is configured to hoist the flag when the image signal is the image for the right eye and to lower the flag when the image signal is the image for the left eye. In the case of the above-mentioned configuration, the calculator 324 and the amplifier 328 determine whether the flag from the flag generator 326 is hoisted or not to determine whether the image signal is the image for the right eye or not.

Further, in this case, although the description indicating whether the image signal is the image for the right eye or the image for the left eye by the flag is made, a system transferring whether the image signal is the image for the right eye or the image for the left eye as the information other than the flag to the calculator 324 and the amplifier 328 may be installed.

The correction amount from the amplifier 328 is supplied to the luminance controller 322. The luminance controller 322 is supplied with the image signal and the correction amount input to the image signal controller 320. The luminance controller 322 performs the correction on the image, that is, the supplied image signal on the basis of the correction amount and outputs the corrected image signal to the image display unit 110. In this case, the image signal of which the luminance value is corrected is output.

In addition, in this case, although the luminance is described by way of example, even when, for example, the color difference other than the luminance is corrected, the correction may be processed by the image signal controller 320 of the configuration shown in FIG. 10. Further, the image signal controller 320 may be configured to correct the luminance and the luminance called the color difference as well as other values.

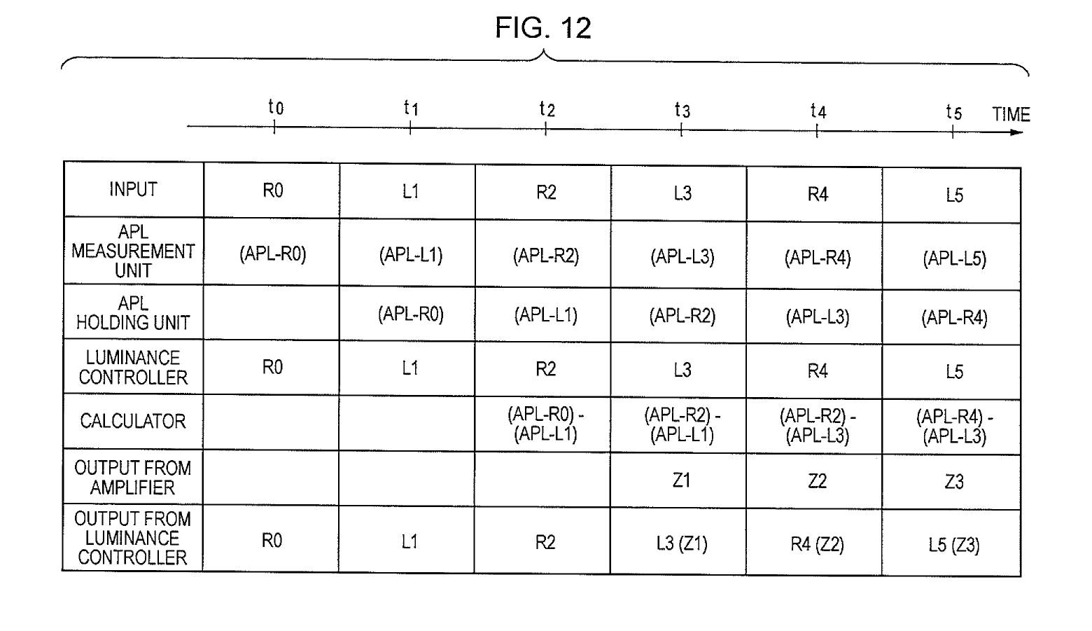

Next, the correspondence relationship between the image signal input to the image signal controller 320 and the output image signal will be described with reference to FIG. 12. When the image signal R0 of the image for the right eye is input to the APL measurement unit 321 at time t0, the APL measurement unit 321 calculates a luminance average value APL-R0. At time t0, the image signal R0 is also input to the luminance controller 322. Since the luminance average value is not input to the APL holding unit 323 or the calculator 324 at time t0, the luminance controller 322 performs the processing of making the correction amount 0 without calculating the correction amount. Therefore, at time t0, the image signal R0 input to the luminance controller 322 is output without change.

At time t1, when the image signal L1 of the image for the left eye is input to the APL measurement unit 321, the APL measurement unit 321 calculates a luminance average value APL-L1. At time t1, the image signal L1 is also input to the luminance controller 322. Further, at time t1, the luminance average value APL-R0 calculated by the APL measurement unit 321 is supplied to the APL holding unit 323 at time t0 and is held. Even at time t1, since the luminance average value from the APL holding unit 323 is not input to the calculator 324, the luminance controller 322 performs the processing of making the correction amount 0 without calculating the correction amount. Therefore, at time t1, the image signal L1 input to the luminance controller 322 is output without change.

At time t2, when the image signal R2 of the image for the right eye is input to the APL measurement unit 321, the APL measurement unit 321 calculates a luminance average value APL-R2. At time t2, the image signal R2 is also input to the luminance controller 322. Further, at time t2, the luminance average value APL-L1 calculated by the APL measurement unit 321 at time t1 is supplied to the APL holding unit 323 and held in the APL holding unit 323 and at the same time, the luminance average value APL-R0 held at time t1 is supplied to the calculator 324. Further, the calculator 324 is supplied with the luminance average value APL-L1 from the APL measurement unit 321.

At time t2, the calculator 324 subtracts the luminance average value APL-L1 from the luminance average value APL-R0 and outputs the difference value to the gain correction unit 325. Even at time t2, since there is no output from the gain correction unit 325, the luminance controller 322 performs the processing of making the correction amount 0 without calculating the correction amount. Therefore, at time t2, the image signal R2 input to the luminance controller 322 is output without change.

At time t3, when an image signal L3 of the image for the left eye is input to the APL measurement unit 321, the APL measurement unit 321 calculates a luminance average value APL-L3. At time t3, the image signal L3 is also input to the luminance controller 322. Further, at time t3, the luminance average value APL-R2 calculated by the APL measurement unit 321 at time t2 is supplied to the APL holding unit 323 and held in the APL holding unit 323 and at the same time, the luminance average value APL-L1 held at time t2 is supplied to the calculator 324. Further, the calculator 324 is supplied with the luminance average value APL-R2 from the APL measurement unit 321.

At time t3, the calculator 324 subtracts the luminance average value APL-L1 from the luminance average value APL-R2 and outputs the difference value to the gain correction unit 325. At time t3, the gain correction unit 325 calculates the correction amount from the input difference value, which is in turn output to the filter 327. The correction amount is subjected to the processing of each of the filter 327 and the amplifier 328 and is supplied to the luminance controller 322. In this case, at time t3, the correction amount output from the amplifier 328 is considered a correction amount Z1.

At time t3, the luminance controller 322 corrects the input image signal L3 with the correction amount Z1 and outputs the corrected image signal L3 (Z1). In this case, the mark of the image signal L3 (Z1) shows the image signal L3 corrected with the correction amount Z1. As described above, the correction amount Z1 is a value calculated from the luminance average value APL-R2 and the luminance average value APL-L1. As described above, in the image signal controller 320, the corrected image signal is corrected by the correction amount calculated from the image signal prior to one frame and the image signal prior to two frames.

At time t4, when an image signal R4 of the image for the right eye is input to the APL measurement unit 321, the APL measurement unit 321 calculates a luminance average value APL-R4. At time t4, the luminance average value APL-L3 calculated by the APL measurement unit 321 at time t3 is supplied to the APL holding unit 323 and held in the APL holding unit 323 and at the same time, the luminance average value APL-R2 held at time t3 is supplied to the calculator 324. Further, the calculator 324 is supplied with the luminance average value APL-L3 from the APL measurement unit 321.

At time t4, the calculator 324 subtracts the luminance average value APL-L3 from the luminance average value APL-R2 and outputs the difference value to the gain correction unit 325. At time t4, a correction amount Z2 is output from the gain correction unit 325 and is subjected to the processing of each of the filter 327 and the amplifier 328 and is then supplied to the luminance controller 322. At time t4, the luminance controller 322 corrects the input image signal R4 with the correction amount Z2 and outputs the corrected image signal R4 (Z2).

At time t5, when an image signal L5 of the image for the left eye is input to the APL measurement unit 321, the APL measurement unit 321 calculates a luminance average value APL-L5. At time t5, the luminance average value APL-R4 calculated by the APL measurement unit 321 at time t4 is supplied to the APL holding unit 323 and held in the APL holding unit 323 and at the same time, the luminance average value APL-L3 held at time t4 is supplied to the calculator 324. Further, the calculator 324 is supplied with the luminance average value APL-R4 from the APL measurement unit 321.

At time t5, the calculator 324 subtracts the luminance average value APL-L3 from the luminance average value APL-R4 and outputs the difference value to the gain correction unit 325. At time t5, a correction amount Z3 is output from the gain correction unit 325 and is subjected to the processing of each of the filter 327 and the amplifier 328 and is then supplied to the luminance controller 322. At time t5, the luminance controller 322 corrects the input image signal L5 with the correction amount Z3 and outputs the corrected image signal L5 (Z3).

The above-mentioned processing is repeated in the image signal controller 320, such that the image signal of which the luminance value is corrected is output. The image based on the corrected image signal is provided to the user, such that for example, the flickering may not be caused.

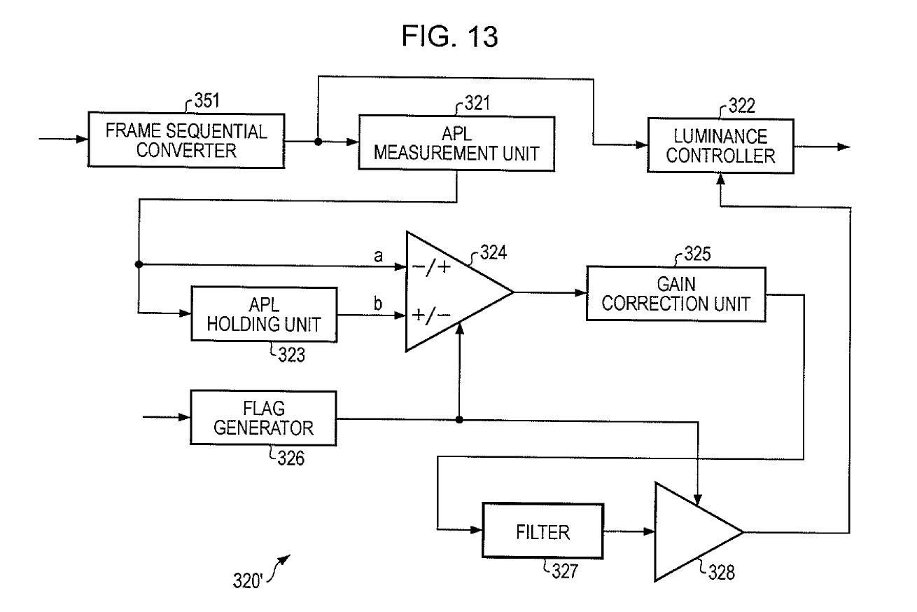

Incidentally, an example of a method of providing the three-dimensional image to the user may mainly include a frame sequential method, a side by side method, and an over and under (that is, top and bottom) method. When the above-mentioned image signal controller 320 corresponds to the frame sequential method, the configuration shown in FIG. 13 may be an image signal controller 320′ and may be the image signal controller 320 corresponding to the side by side method or the over and under (that is, top and bottom) method.

The image signal controller 320′ shown in FIG. 13 (described by attaching an apostrophe to differentiate from the image signal controller 320 shown in FIG. 10) is configured to add a frame sequential converter 351 to the image signal controller 320 shown in FIG. 10. The frame sequential converter 351 performs conversion processing from the side by side method to the frame sequential method to supply the converted image signal to the APL measurement unit 321 or performs conversion processing from the over and under (that is, top and bottom) method to the frame sequential method to supply the converted image signal to the APL measurement unit 321.

The processing after being converted into the frame sequential method by the frame sequential converter 351 is similar to the image signal controller 320 shown in FIG. 10 and therefore, the description thereof will not be repeated herein. The above-mentioned converter is installed, such that the processing may be performed regardless of the use of any method.

Incidentally, the human eye has a characteristic of being sensitive to a black side. Since the human eye reacts sensitively to the change in luminance at the black side rather than the change in luminance at the white side, for example, the luminance value of the black side rather than the luminance value of the white side may be intensively processed.

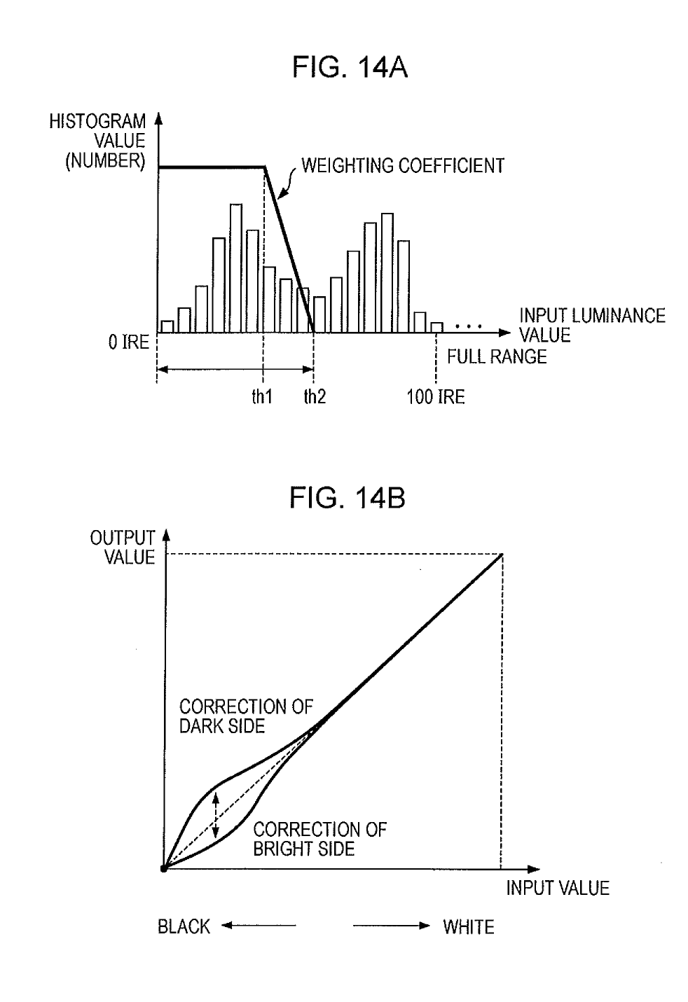

For example, in the image signal controller 320 shown in FIG. 10, the APL measurement unit 321 may be configured to calculate the APL of the black side. In detail, the APL measurement unit 321 may be configured to calculate the luminance average value obtained by intensively processing the luminance value of the black side by using weighting coefficients as shown in FIG. 14A. In a graph shown in FIG. 14A, a horizontal axis indicates an input luminance value and a vertical axis indicates a histogram value. From a minimum value to a maximum value of the considered luminance value is divided into, for example, 100 sections. The APL measurement unit 321 calculates the luminance value from the input image signal and calculates the number of luminance values present in each section, such that the graph of the histogram as shown in FIG. 14A is prepared for each section.

In the graph shown in FIG. 14A, the left side of FIG. 14A indicates the luminance value of the black side and the right side thereof indicates the luminance value of the white side. The weighting coefficients are set to the luminance values present from section 0 to section th2. The weighting coefficients become a constant value from section 0 to section th1 and become a value reducing with a linear function from section th1 to section th2. The APL measurement unit 321 multiplies the number of luminance values present in a predetermined section by the weighting coefficient given corresponding to the predetermined section. The above-mentioned multiplication is performed over the overall section and all the multiplied results are added and are divided by the number of sections (in this case, 100), thereby calculating the average value. The value calculated according to the above description is used as the above-mentioned luminance average value.

Further, when the weighting coefficients as shown in FIG. 14A are used, the weighting coefficients are “0” in sections of section th2 or more and therefore, are 0 even in the case of adding the weighting coefficients, such that from section 0 to section th2 may be an object of the calculation and it may be enough to calculate the average value from section 0 to section th2. In this case, since it is not necessary to process the sections of section th2 or more, the burden of the processing may be reduced.

As described above, FIG. 14B shows the gamma characteristics in the case in which the processing is performed by calculating the average value of the luminance values of the black side. As shown in FIG. 14B, the gamma characteristic of the black side has characteristics that are corrected so that the output value is larger than the input value when being corrected to a dark side and that are corrected so that the input value is smaller than the output value when being corrected to a bright side. In order to implement the above-mentioned gamma characteristics, the gain correction unit 325 is configured to calculate the correction amount.

Further, although the embodiment describes the case of performing the processing using the weighting coefficients so that the APL measurement unit 321 (image signal controller 320) may intensively process the luminance of the black side, for example, the left eye image measurement unit 121a or the right eye image measurement unit 121b of the image signal controller 120 shown in FIG. 3 may perform the above-mentioned processing and therefore, the embodiment is not limited to the APL measurement unit 321 performing the above-mentioned processing.

Further, in the embodiment of the present disclosure, the correction processing may be performed once and may be performed multiple times until the difference is less than the predetermined threshold value.

Since even the case in which the image for the right eye and the image for the left eye are corrected by the above-mentioned luminance average value of the black side is the correction according to the characteristics of an eye, the correction to prevent, for example, flickering from occurring may be performed.

The series of processes described in the embodiment of the present disclosure may be performed by dedicated hardware but may be performed by software. When the series of processes are performed by software, a recording medium recording a computer program is stored in the display device 100 and the series of processes may be implemented by executing the computer program by a CPU or other control devices. Further, when the series of processes are performed by software, the recording medium recording the computer program is stored in a dedicated or general-purpose computer and the series of processes may be implemented by executing the computer program by a CPU or other control devices.

### 4. Overview

As described above, although the exemplary embodiment of the present disclosure was described with reference to the accompanying drawings, the embodiment of the present disclosure is not limited thereto. It is apparent that a person skilled in the art to which the present disclosure pertains can implement various modifications and alterations without departing from the scope of the appended claims and it should be understood that they belong to the scope of the present disclosure.

For example, although the above embodiment may divide the image into the plurality of blocks to determine the correction amount for only the blocks in which the dispersion of the luminance or the color difference is the predetermined threshold value or more when determining the correction amount, the embodiment of the present disclosure is not limited thereto. For example, the embodiment of the present disclosure may divide the image into the plurality of blocks to determine the correction amount for a central block (in the above embodiment, for example, seventh to ninth blocks, twelfth to fourteenth blocks, and seventeenth to nineteenth blocks) in which the left and right disparity is small. Further, the embodiment of the present disclosure may determine the correction amount for only the block in which the dispersion of the luminance or the color difference is also the predetermined threshold value or more after the block determining the correction amount is limited to the central block.

Further, for example, as the result of analyzing the image for the left eye and the image for the right eye, when the characters are included in the image, the correction amount may be determined in the correction amount determination units 123 and 223 so that the luminance or the color difference of the portion corresponding to the character is matched. Further, for example, the correction amount may be determined in the correction amount determination units 123 and 223 according to the analysis of the image for the left eye and the image for the right eye and the contents included in the image. For example, when the image includes relatively high proportion of scenery, the correction amount may be determined in the correction amount determination units 123 and 223 so that the luminance or the color difference of the portion corresponding to the scenery is matched. Further, when the image includes relatively many people, the correction amount may be determined in the correction amount determination units 123 and 223 so that the luminance or the color difference of the portion corresponding to the people is matched.

Further, for example, as the result of analyzing the image for the left eye and the image for the right eye, when the image is computer graphics, the correction amount determination units 123 and 223 may omit the calculation of the correction amount, such as deliberately not performing the correction.

The present disclosure contains subject matter related to that disclosed in Japanese Priority Patent Application JP 2010-124997 filed in the Japan Patent Office on May 31, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a first measurement unit measuring information on luminance of a first image signal to output a first measurement result;
a second measurement unit measuring information on a luminance of a second image signal to output a second measurement result;
a comparator comparing the first measurement result with the second measurement result to output differential data;
a correction amount determination unit determining a correction amount for the first image signal and/or the second image signal based on the differential data; and
a correction unit correcting the luminance of the first image signal and/or the second image signal based on the correction amount.

2. The display device according to claim 1, wherein the first measurement unit and the second measurement unit measure the information on colors of the first image signal and the second image signal to output the first measurement result and the second measurement result.

3. The display device according to claim 1, wherein the first measurement unit and the second measurement unit divide the first image signal and the second image signal into a plurality of areas to perform the measurement on each area.

4. The display device according to claim 3, wherein the correction amount determination unit determines the correction amount only for the area in which the first measurement result and the second measurement result are equal to or more than a predetermined threshold value.

5. The display device according to claim 3, wherein the correction amount determination unit determines the correction amount for only an area of a central portion in the plurality of areas.

6. The display device according to claim 5, wherein the correction amount determination unit further determines the correction amount for only the area in which the first measurement result and the second measurement result are equal to or more than a predetermined threshold value.

7. The display device according to claim 1, wherein the comparator outputs a difference square sum of the first measurement result and the second measurement result as the differential data.

8. The display device according to claim 1, wherein the correction amount determination unit determines the correction amount in response to the contents of the image displayed by the first image signal and the second image signal.

9. The display device according to claim 1, further comprising a display unit displaying the three-dimensional image based on the corrected first image signal and second image signal.

10. The display device according to claim 1, wherein the first measurement unit and the second measurement unit applying weighting to information on a black side of the information on the measured luminance to output the first measurement result and the second measurement result.

11. A display method comprising:
measuring information on luminance of a first image signal to output a first measurement result;
measuring information on a luminance of a second image signal to output a second measurement result;
comparing the first measurement result with the second measurement result to output differential data;
determining a correction amount for the first image signal and/or the second image signal based on the differential data; and
correcting the luminance of the first image signal and/or the second image signal based on the correction amount.

12. A computer program that allows a computer to execute:
measuring information on luminance of a first image signal to output a first measurement result;
measuring information on a luminance of a second image signal to output a second measurement result;
comparing the first measurement result with the second measurement result to output differential data;
determining a correction amount for the first image signal and/or the second image signal based on the differential data; and
correcting the luminance of the first image signal and/or the second image signal based on the correction amount.
